(19) United States
(12) Patent Application Publication
(10) Pub. No.: US 2017/0308611 A1
(43) Pub. Date: Oct. 26, 2017

(54) PERSONAL RELATIONSHIP NETWORK SEARCH SYSTEM AND METHOD THEREFOR

(71) Applicant: Ki-won Nam, Seoul (KR)

(72) Inventor: Gil-ju Park, Daejeon (KR)

(21) Appl. No.: 15/520,076

(22) PCT Filed: Oct. 20, 2015
(86) PCT No.: PCT/KR2015/011091

§ 371 Date: Apr. 19, 2017

(30) Foreign Application Priority Data
Oct. 20, 2014 (KR) 10-2014-0141905

(51) Int. Cl. G06F 17/30; G06Q 50/00

(52) U.S. Cl. CPC G06F 17/30864; G06Q 50/01

(57) ABSTRACT

A personal relationship search system allows a user to, when establishing a relationship with a new person, search whether the new person is a person included in a personal relationship network like an acquaintance of an acquaintance, thereby shortening an establishment period of strong relationship. By applying the system, it is possible to search a specific newly met person using a personal relationship network formed by acquaintances stage by stage to determine whether a relationship searcher of the person is included in the personal relationship network of the user, thereby rapidly increasing affinity and establishing a sincerer relationship. Further, it is possible to know the affinity between the acquaintance and the relationship searcher, and be provided with comments of the acquaintance for the relationship searcher, as a result, a preferable relationship in general relationship or business relationship may be established.

### TECHNICAL FIELD

The present invention relates to a personal relationship search system and a method therefor, and more particularly, to a personal relationship search system and a method therefor that allows a user to, when establishing a relationship with a new person, search whether the new person is a person included in a personal relationship network like an acquaintance of an acquaintance thereof, thereby shortening an establishment period of a strong relationship.

### BACKGROUND ART

As well known in the art, in accordance with recent development of information communication techniques, a technique for information service that provides information on various fields by a wide area data communication network in real time to multiple subscribers through at least one host server has been actively developed.

Based on the techniques, recently, a peripheral technique such as a cache memory expansion technique for more rapidly providing accurate information to subscribers and an information sorting and compression technique for more conveniently accessing taste and preference of the subscribers have been developed, and accordingly, development of various contents and solutions thereof is also accelerated.

However, even though advanced techniques are rapidly developed, processes of introducing and being introduced to a person primarily occur offline face-to-face.

Generally, a new person in a relationship may be an acquaintance of an acquaintance thereof, or another acquaintance of an acquaintance of the acquaintance thereof, but there is no means for checking the relationship, thus it is not possible to have an opportunity to become close in a short period of time, and to know whether the new person is a person who is reliable and may be a good partner for business in terms of work.

Further, when a person newly met in a business relationship is an acquaintance of an acquaintance thereof, since there is no means for allowing persons in the new relationship to know the relationship, there may be a case in which the persons may not work sincerely and faithfully in business.

In particular, there is also a case of being disrespectful to a person met in business, and later, knowing that the person is an acquaintance of the acquaintance thereof. In this case, problems may occur in a relationship with the person met in business and with the acquaintance as well.

### DISCLOSURE

### Technical Problem

Accordingly, it is an object of the present invention to provide a personal relationship search system and a method therefor that allows a user to, when establishing a relationship with a new person, search whether the new person is a person included in a personal relationship network like an acquaintance of an acquaintance thereof, thereby shortening an establishment period of a strong relationship.

### Technical Solution

In order to accomplish the above objects, there is provided a personal relationship network search method, including: a) receiving, by a first personal relationship search application 4a installed in a first user terminal 2a, a relationship searcher; b) transmitting, by a first personal relationship search application 4a, relationship searcher information to a second personal relationship search application 4b of an acquaintance stored in a contact list 10; c) determining, by the second personal relationship search application 4b, whether the relationship searcher is pre-stored in a contact list 10 of a second user terminal 2b; and d) when the relationship searcher is pre-stored, transmitting, by the second personal relationship search application 4b, the personal relationship information to the first personal relationship search application 4a.

Preferably, in the step b), first user information or a phone number of the first user terminal 2a is further transmitted together with the relationship searcher.

Preferably, the method further includes: before the step a), registering, by the second personal relationship search application 4b, personal information of a second user to be searchable.

Preferably, the method further includes: before the step a), storing the same type of identification information as the relationship searcher in the contact list 10 of the second user terminal 2b.

Preferably, the step d) further includes, when the relationship searcher is pre-stored, checking, by the second personal relationship search application 4b, whether both of the acquaintance and the relationship searcher store each other's phone number, and transmitting the checked information to the first personal relationship search application 4a to determine a level of affinity.

Preferably, the method further includes: before the step a), performing, by the second personal relationship search application 4b, a setting so that a search in the personal contact list 10 is not allowed when the first personal relationship search application 4a requests a search for a specific person, and editing so that a remote search in the contact list is not allowed.

Preferably, the step d) further includes, transmitting, information on a fact that the first personal relationship search application 4a requests a search for the relationship searcher to the second personal relationship search application 4b.

Preferably, the step d) further includes, if the second personal relationship search application 4b fails to search the relationship searcher, expanding a personal relationship pool to be searched to a third personal relationship search application 4c of acquaintances stored in a contact list 10 of a second user.

Preferably, the method further includes: before the step a), performing, by the second personal relationship search application 4b, a setting so that a specific acquaintance of acquaintances included in a personal contact list 10 is unsearchable, and editing the personal contact list 10.

Preferably, the method further includes: after the step d), outputting, by the second personal relationship search application 4b, an input window, in which comment information for the relationship searcher is input when receiving search request attempt information for the relationship searcher, and is transmitted to the first personal relationship search application 4a, on a screen; and transmitting the comment information to the first personal relationship search application 4a at the time of inputting the comment.

According to another aspect of the present invention, there is provided a personal relationship network search system, including: a first personal relationship search application 4a installed in a first user terminal 2a owned by a first user, and configured to search whether a specific relationship searcher is included in a personal relationship network that is formed based on a personal contact list 10 opened to be searchable to acquaintances, and request to determine that the specific relationship searcher is included in any acquaintance's personal contact list 10; and a second personal relationship search application 4b installed in a second user terminal 2b owned by a second user who is an acquaintance of the first user, and configured to compare the specific relationship searcher with a personal contact list 10 thereof by receiving from the first personal relationship search application 4a a request signal for searching whether the specific relationship searcher is included in the personal contact list thereof, and transmit a signal informing that a person having the specific relationship searcher is an acquaintance to the first personal relationship search application 4a when the specific relationship searcher is included in the personal contact list 10.

Preferably, whether a phone number of a user terminal 2 having a personal contact list 10 in which the relationship searcher is searched is registered in a personal contact list 10 of the relationship searcher is checked through a personal relationship search application 4 owned by the relationship searcher.

Preferably, the personal relationship search application 4 checks to which the relationship searcher belongs any classification (family, customer, friend, relative, others) in the personal contact list 10 in which the relationship searcher is searched, and transmits the result to the user attempting the search.

Preferably, the second personal relationship search application 4b performs a setting so that a search in the personal contact list 10 is not allowed when the first personal relationship search application 4a requests a search for a specific person.

Preferably, the second personal relationship search application 4b performs a setting so that a specific acquaintance of acquaintances included in the personal contact list 10 is unsearchable.

Preferably, the second personal relationship search application 4b is configured to check a call frequency with respect to the specific relationship searcher in association with a call circuit unit 20 and transmit the checked result to the first personal relationship search application 4a.

Preferably, the second personal relationship search application 4b includes an input window, in which comment information for the specific relationship searcher is input in response to search request attempt information of the first personal relationship search application 4a with respect to the specific relationship searcher, and is transmitted to the first personal relationship search application 4a.

Preferably, the system further includes: a personal relationship information management server configured to store the same information included in the personal contact list 10s of the first and second personal relationship search applications 4a and 4b in advance, and extract and provide information on whether the specific relationship searcher is present and personal relationship network information (information on connection route between users to the relationship searcher) thereof in response to a search request for the relationship searcher from the first and second personal relationship search applications 4a and 4b.

Preferably, the first and second personal relationship search applications 4a and 4b are configured to indicate an index of a level of affinity by an input of a selection of the user with respect to an acquaintance included in the personal contact list 10 and provide the index of the level of affinity to a user attempting a search at the time of searching for the acquaintance.

Preferably, the first and second personal relationship search applications 4a and 4b are configured to indicate the number of offline face-to-face meeting with each acquaintance within a predetermined period by an input of a selection of the user with respect to an acquaintance included in the personal contact list 10 and provide the number of offline face-to-face meeting to a user attempting a search at the time of searching for the acquaintance.

### Advantageous Effects

In accordance with the personal relationship search system and the method therefor according to the present invention, it is possible to search the relationship searcher newly met by using a personal relationship network that is formed by acquaintances stage by stage with respect to a specific relationship searcher to determine whether the relationship searcher of the person is included in the personal relationship network of the user, thereby more rapidly increasing affinity and establishing a sincerer relationship. Further, it is possible to know the affinity between the acquaintance and the relationship searcher, and be provided with comments of the acquaintance for the relationship searcher, as a result, a preferable relationship in general relationship or business relationship may be established.

### DESCRIPTION OF DRAWINGS

FIG. 1 is a schematic view illustrating a configuration of a personal relationship network search system according to an embodiment of the present invention.

FIG. 2 is a diagram illustrating a personal relationship network of the personal relationship network search system according to the embodiment of the present invention.

FIG. 3 is a diagram illustrating an operation state of a personal relationship search application and a contact list included in the personal relationship network search system according to the embodiment of the present invention.

FIG. 4 is a view illustrating a personal relationship diagram of the personal relationship network search system according to the embodiment of the present invention.

FIG. 5 is a diagram illustrating a configuration of the contact list included in the personal relationship network search system according to the embodiment of the present invention.

FIG. 6 is a flow chart illustrating a signal flow of the personal relationship network search system according to the embodiment of the present invention.

FIG. 7 is a flow chart illustrating a process for checking a level of affinity through the personal relationship network search system according to the embodiment of the present invention.

FIG. 8 is a diagram illustrating a personal relationship search state in accordance with a privacy setting through the personal relationship network search system according to the embodiment of the present invention.

FIG. 9 is a diagram illustrating an affinity check state based on an access frequency through the personal relationship network search system according to the embodiment of the present invention.

FIG. 10 is a diagram illustrating a transmission state of a comment on a relationship searcher through the personal relationship network search system according to the embodiment of the present invention.

### BEST MODE

Hereinafter, the present invention will be described in detail with reference to drawings.

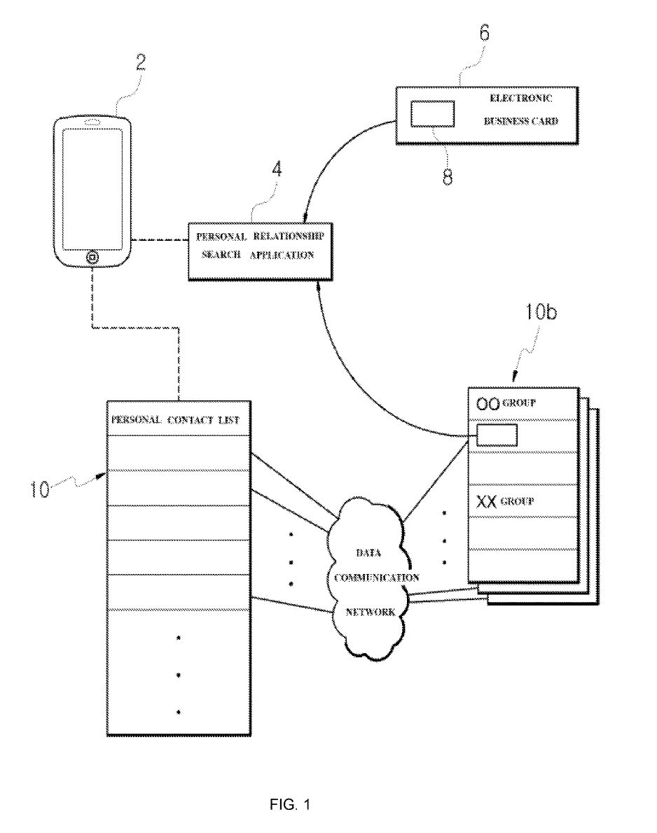

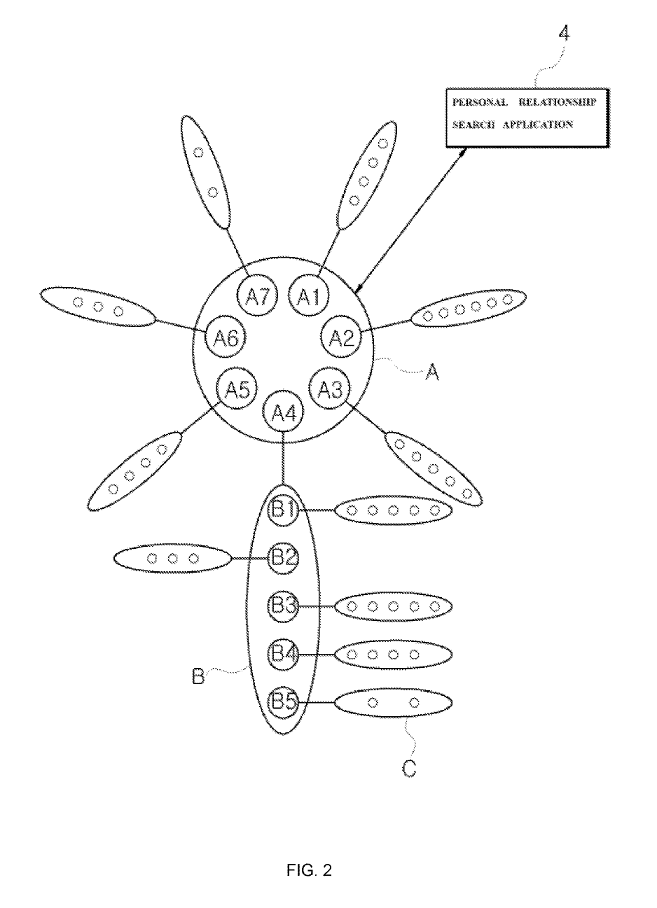

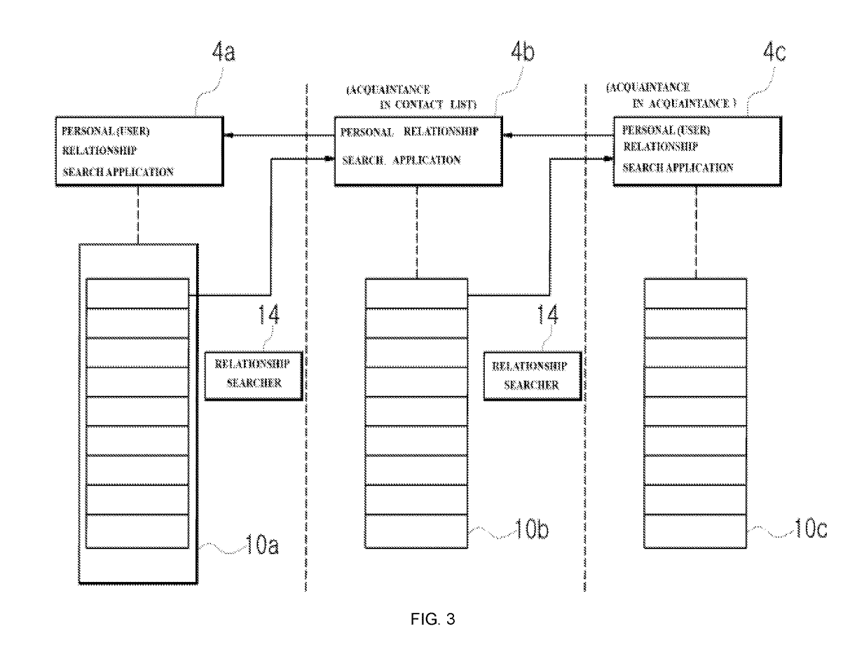

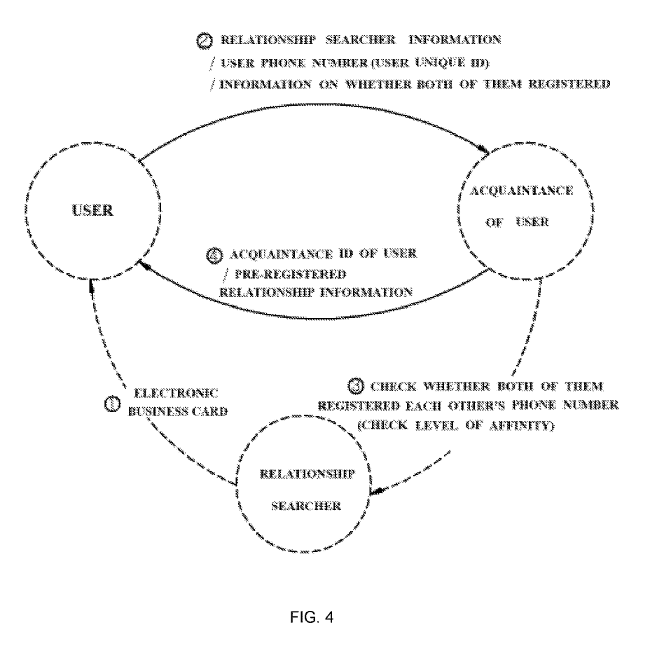

FIG. 1 is a schematic view illustrating a configuration of the personal relationship network search system according to an embodiment of the present invention, FIG. 2 is a diagram illustrating a personal relationship network of the personal relationship network search system according to the embodiment of the present invention, FIG. 3 is a diagram illustrating an operation state of a personal relationship search application and a contact list included in the personal relationship network search system according to the embodiment of the present invention, and FIG. 4 is a view illustrating a personal relationship diagram of the personal relationship network search system according to the embodiment of the present invention.

Referring to FIGS. 1 to 4, the personal relationship network search system according to the embodiment of the present invention is a system that allows a user to, when establishing a relationship with a new person, search whether the new person is a person included in a personal relationship network like an acquaintance of an acquaintance thereof, thereby shortening an establishment period of a strong relationship.

That is, the personal relationship network search system according to the embodiment of the present invention is a system for seeking a faithful and sincere relationship with a person to be newly included in the personal relationship network that is expanding in society by searching whether the person is a person included in an existing personal relationship network of the user.

For example, when meeting a new person in business or other environments, if the user may search whether the new person is an acquaintance of an acquaintance of the user, the user may sincerely establish a relationship with the new person. Such an improvement in relationship is not limited to the user, and if the person also recognizes that the user is included in the personal relationship network, similarly, the person will try to establish a sincere relationship with the user.

In this case, according to the embodiment of the present invention, a means for indicating a name of a newly met person, a company name, a place name, etc. to be able to be searched, is named a “relationship searcher 14.”

That is, the relationship searcher 14 is an item included in a name of a specific person, a specific company name, a specific phone number, a specific place name, or personal information which is an object to be searched.

Particularly, the relationship searcher 14 is indicated as unique identification information and configured to be distinguished from other relationship searchers.

Generally, when receiving an electronic business card 6 or an ordinary business card by meeting a new person, personal information 8 is provided in the business card, and the relationship searcher 14 which is unique information indicating the person is included in the personal information 8. The present invention is a technique for searching whether the relationship searcher 14 is included in the personal relationship network of the user by using the relationship searcher 14, and finding out information thereof.

To this end, the personal relationship network search system according to the embodiment of the present invention includes a first personal relationship search application 4a installed in a first user terminal 2a owned by a first user, and configured to search whether a specific relationship searcher is included in the personal relationship network that is formed based on a personal contact list 10 opened to be searchable to acquaintances, and request to determine that the specific relationship searcher is included in any acquaintance's personal contact list 10.

Further, the personal relationship network search system according to the embodiment of the present invention includes a second personal relationship search application 4b installed in a second user terminal 2b owned by a second user who is an acquaintance of the first user, and configured to compare the specific relationship searcher with a personal contact list 10 thereof by receiving from the first personal relationship search application 4a a request signal for searching whether the specific relationship searcher is included in the personal contact list thereof, and transmit a signal informing that a person having the specific relationship searcher is an acquaintance to the first personal relationship search application 4a when the specific relationship searcher is included in the personal contact list 10.

That is, the personal relationship network search system according to the embodiment of the present invention may form the personal relationship network based on a contact list 10 included in each user terminal 2 through the personal relationship search application 4 installed in each user terminal 2, and since unique identification information such as a unique ID or a phone number of a specific person, a unique company name, etc. is stored in the contact list 10, as illustrated in FIG. 2, it is possible to determine whether specific identification information is included in the personal relationship network around any one user, and determine the identification information is positioned in any classification.

Referring to FIG. 2, when it is assumed that a contact list of the first user is “A,” and the person newly met is a person having identification information “C1,” a first stage personal relationship network is formed based on personal relationships stored in contact lists of each of many acquaintances, for example, A1, A2, A3, A4, A5, A6 and A7, stored in the contact list A of the first user.

The first stage personal relationship network has a range including personal relationships containing “acquaintances of acquaintances A1, A2, A3, A4, A5, A6 and A7,” and for example, a range including B1, B2, B3, B4 and B5 corresponds to the above range.

When a search object (e.g. C1) that is a desired relationship searcher does not belong to the first stage personal relationship network, the personal relationship network search system according to the embodiment of the present invention expands a search range to a second stage personal relationship network through the personal relationship search application 4.

The second stage personal relationship network has a range including personal relationships containing “acquaintances of acquaintances (acquaintances including B1, B2, B3, B4 and B5) of acquaintances A1, A2, A3, A4, A5, A6 and A7,” and for example, a range including C1 and C2 corresponds to the above range.

Thereby, it is possible to know that the relationship searcher “C1” that is first desired to be searched is an acquaintance of “B5,” as a result, it is possible to know that “C1” is “another acquaintance of an acquaintance of the acquaintance” about the user.

Further, in this case, a third personal relationship search application 4c installed in the user terminal 2 corresponding to “an acquaintance B5 of an acquaintance A4” provides information based on which it is possible to know that the first user performed a search for “C1 who is an acquaintance of B5” to the second personal relationship search application 4b installed in the user terminal 2 owned by “A4” who is an acquaintance.

Similarly, the third personal relationship search application 4c provides personal relationship route information, that is, “C1 being an acquaintance of B5 who is an acquaintance of A4” to the first personal relationship search application 4a installed in the terminal 2 of the first user.

In this case, a search request signal and a search result signal for the specific relationship searcher are transmitted and received between the first personal relationship search application 4a and the second personal relationship search application 4b in a relay method through multiple acquaintance stages by a plurality of different personal relationship search applications 4.

That is, according to the present invention, in the personal relationship network formed based on the contact list 10, it is possible to obtain information on whether a specific relationship searcher is present in the contact list 10, and if present, the specific relationship searcher is present in any contact list 10, and a level of affinity between the user and the acquaintance, by communication through a plurality of personal relationship search applications 4.

Further, according to the present invention, when the relationship searcher is present in a contact list 10 of an acquaintance, in order to check the affinity between the relationship searcher and the acquaintance, whether a phone number of the acquaintance is registered in the contact list 10 of the relationship searcher may be determined.

In addition, it is possible to confirm that a user terminal 2 having the personal contact list 10 in which the relationship searcher is a user terminal 2 of the stage number from the personal contact list 10 of the acquaintance of the first user through the first personal relationship search application 4a.

That is, whether a specific person who wants to search by the user is present in the contact list of the acquaintance, or in a contact list of an acquaintance of the acquaintance thereof, or in a contact list of another acquaintance of an acquaintance of the acquaintance may be determined by the user through communication between the personal relationship search applications 4. Such an operation may be possible as all users install the personal relationship search application 4 in the user terminal 2 and the personal relationship search application 4 is operated in association with the contact list 10 included in the user terminal 2.

Meanwhile, the personal relationship network search system according to the embodiment of the present invention is configured so that information pre-registered by each of the users in the contact lists 10 of each of the users in association with the first and second personal relationship search applications 4a and 4b may be transmitted to the user attempting to search information. Therefore, when an attempt to search personal relationship network is performed through acquaintances in the present invention, the information pre-registered by the user is transmitted together through the personal relationship network.

Further, according to the present invention, it is possible to form the personal relationship network by a network through the personal relationship search applications 4 installed in the user terminals 2, respectively, and it is also possible to construct a personal relationship information management server (not illustrated) to form the personal relationship network by networking so that the contact lists included in the respective user terminals 2 is operated in association with a separate server, and connecting the contact lists 10 to each other.

The personal relationship information management server (not illustrated) is an equivalent configuration since an operation, an effect, a function, and a purpose thereof may form the same personal relationship network as that constructed by the personal relationship search applications 4.

More specifically, the present invention may include the personal relationship information management server that stores the same information included in the personal contact lists 10 of the first and second personal relationship search applications 4a and 4b in advance, and extracts and provides information on whether a specific relationship searcher is present and personal relationship network information (information on connection route between users to the relationship searcher) thereof in response to a search request for the relationship searcher from the first and second personal relationship search applications 4a and 4b.

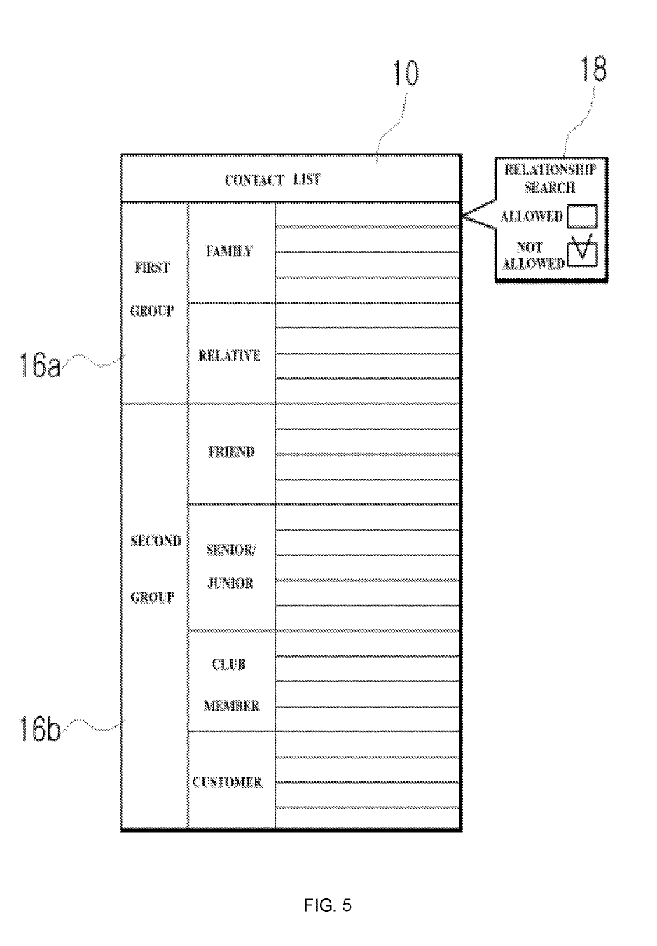

FIG. 5 is a diagram illustrating a configuration of the contact list included in the personal relationship network search system according to the embodiment of the present invention.

Referring to FIG. 5, the personal relationship search application 4 included in the personal relationship network search system according to the embodiment of the present invention may determine whether specific information is included in the contact list in association with the contact list 10, determine to which the specific information belongs any group, and set a specific phone number to be unsearchable by other users.

That is, the personal relationship search application 4 may check to which the relationship searcher belongs any classification (family, customer, friend, relative, others) in the personal contact list 10 in which the relationship searcher is searched, and transmit the result to the user attempting the search.

In this case, groups in the contact list 10 may be classified based on a level of affinity, for example, families and relatives are classified as a first group 16a, friends, seniors/juniors, club members, and customers are classified as a second group 16b. It is preferable that only information of a group to which the relationship searcher belongs is provided to the user attempting the search.

Further, since the phone number information stored in the contact list 10 may be opened to be searchable or may remain private to be unsearchable when relationship search is attempted, each contact list 10 is provided with a separate search privacy setting window 18.

Functions and operation of the personal relationship network search system according to the embodiment of the present invention configured as described above will be described in detail with reference to the accompanying drawings.

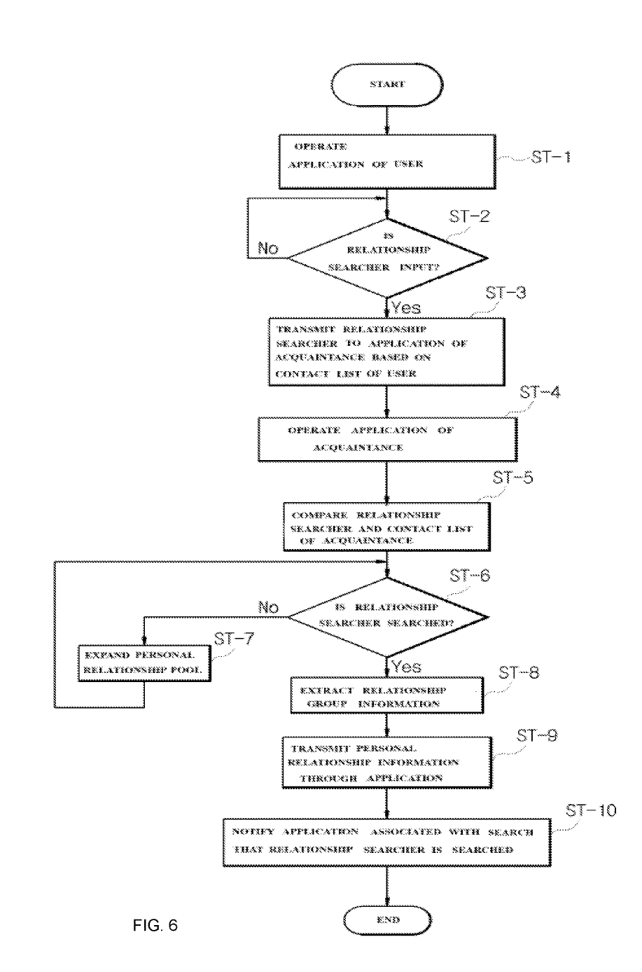

FIG. 6 is a flow chart illustrating a signal flow of the personal relationship network search system according to the embodiment of the present invention.

First, in order to receive a service for forming the personal relationship network, searching a specific person or a specific person associated with a specific company, and finding a position of the specific person in the personal relationship network about the user, each user needs to install the personal relationship search application 4 in the user terminal 2.

Meanwhile, in the personal relationship network search system according to the embodiment of the present invention, it is necessary for a person to be searched, as well as the users included in the personal relationship network to receive a relationship searcher (relationship search factor) which is unique identification information.

The relationship searcher is an item included in a name of a specific person, a specific company name, a specific phone number, a specific place name, or personal information which is an object to be searched.

Further, the relationship searcher may be distributed with being included in an electronic business card, and may also be registered in the personal relationship search application 4 together with personal information.

In that state, when the first user newly meets a specific person, a relationship searcher included in an electronic business card, etc. provided by the specific person may be recognized and the relationship searcher of the specific person may be input to the first personal relationship search application 4a installed in the first user terminal 2a.

Then, the first personal relationship search application 4a transmits the relationship searcher information to a user terminal of an acquaintance stored in the contact list 10a of the first user terminal 2a, that is, the second personal relationship search application 4b installed in the second user terminal 2b to query whether the relationship searcher information is included in the contact list 10b of the second user.

In this case, the second personal relationship search application 4b needs to know from who the search request for the relationship searcher is transmitted. Therefore, the first personal relationship search application 4a transmits the first user information or a phone number of the first user terminal 2a together with the relationship searcher to the second personal relationship search application 4b.

When a personal relationship pool of the personal relationship network is more expanded, and thus the search request information of the first personal relationship search application 4a is transmitted to the third personal relationship search application 4c via the second personal relationship search application 4b, the second user information or a phone number of the second user terminal 2b is transmitted together to the third personal relationship search application 4c.

That is, the user may recognize who is searching the user's phone number by checking which acquaintance of acquaintances of the user is searching the user's phone number, thus information transmission is performed between the applications so that only information of acquaintances in the first stage about the user having the searched contact list may be transmitted.

In that state, the second personal relationship search application 4b determines whether the relationship searcher is pre-stored in the contact list 10 of the second user terminal 2b, that is, the second personal relationship search application 4b determines whether the relationship searcher is stored in the contact list 10 of the second user terminal 2b.

When the relationship searcher is pre-stored, the second personal relationship search application 4b transmits the personal relationship information to the first personal relationship search application 4a.

In particular, when the relationship searcher is searched, the second personal relationship search application 4b determines to which acquaintance stage the search for the relationship searcher belongs. That is, more specifically, how much the first user and the specific person owning the relationship searcher are close to each other is determined by receiving group classification information.

When the specific person belongs to the first group, the specific person is a family or a relative, thus it may be assumed that the level of affinity therebetween is very high.

Meanwhile, according to the present invention, it is preferable that information on the fact that the user's contact list 10 is searched may be provided to the user, thus, for example, information on the fact that the first personal relationship search application 4a has requested the search for the specific relationship searcher is provided to the second personal relationship search application 4b.

If the second personal relationship search application 4b fails to search the specific relationship searcher, the personal relationship pool is expanded to the third personal relationship search application 4c of acquaintances stored in the contact list 10 of the second user.

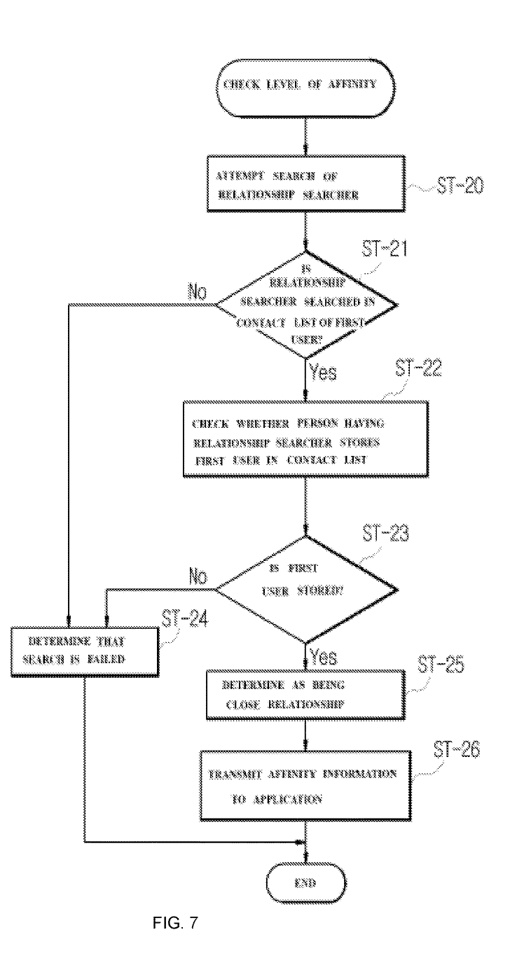

FIG. 7 is a flow chart illustrating a process for checking the level of affinity through the personal relationship network search system according to the embodiment of the present invention.

First, when a specific relationship searcher is searched through the personal relationship network search system according to the embodiment of the present invention, the user attempting the search may want to know the level of affinity between the acquaintance storing the relationship searcher in the contact list and a user owning the relationship searcher.

Therefore, if the specific relationship searcher is searched, basic affinity may be checked by checking whether both of the acquaintance storing the relationship searcher in the contact list and the user owning the relationship searcher store each other's phone number as a method for checking the level of affinity therebetween.

That is, when both of them store each other's phone number in the contact list, it may be determined that the affinity therebetween is at least a basic level. If only one of them stores the other one's phone number in the contact list thereof, and the other one does not store the one's phone number in the contact list, it may be assumed that only one-way affinity is present.

Accordingly, when the relationship searcher is pre-stored, the second personal relationship search application 4b checks whether both of the acquaintance and the user having the relationship searcher store the each other's phone number, and transmitting the checked information to the first personal relationship search application 4a, thereby determining the level of affinity therebetween.

Meanwhile, it is also possible to more quantitatively check the level of affinity. For example, it is possible to indicate an index of the level of affinity by an input of a selection of the user with respect to a plurality of acquaintances stored in the contact list 10 in association with the personal relationship search application 4 distributed through the personal relationship network search system according to the embodiment of the present invention, and provide the index of the level of affinity at the time of searching a specific person.

That is, in a state in which Yeonghee and Cheolsu are stored in a user's contact list, and the user sets Yeonghee as having two stars, and sets Cheolsu as having five stars, when an acquaintance of an acquaintance searches a personal relationship with Cheolsu, the acquaintance of the acquaintance may know that the user and Cheolsu have a very close relationship with each other, and a relationship between the user and the acquaintance may be indicated with an index, and a relationship between the acquaintance and the acquaintance of the acquaintance may also be indicated with an index. Therefore, a person searching Cheolsu may roughly predict personality of Cheolsu.

Such a method is very useful at the time of constructing the personal relationship network since a third party may quantitatively recognize how much the user and the person to be searched are close to each other.

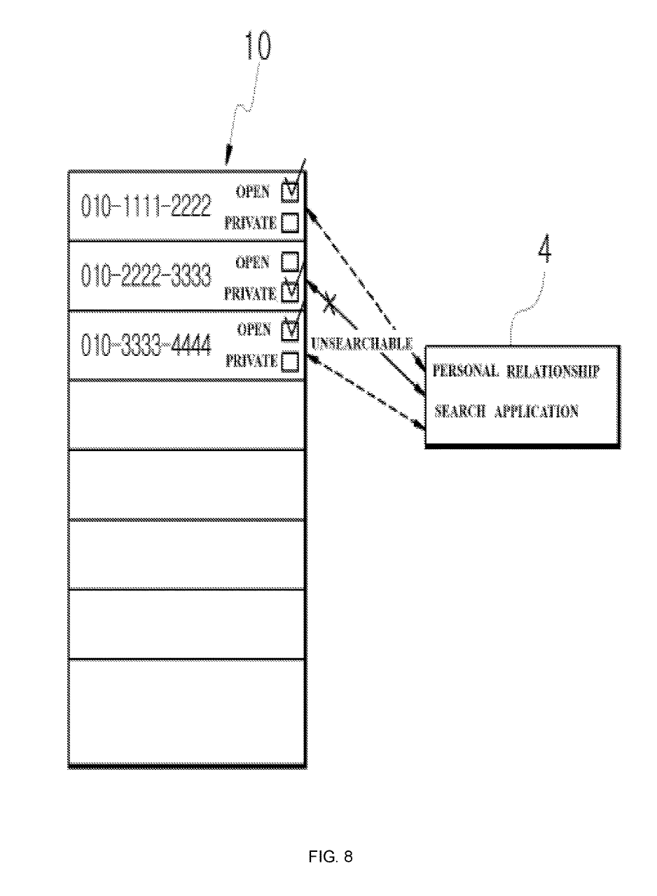

FIG. 8 is a diagram illustrating a personal relationship search state in accordance with a privacy setting through the personal relationship network search system according to the embodiment of the present invention.

Referring to FIG. 8, according to the personal relationship network search system according to the embodiment of the present invention, with respect to a specific person who is a search object, the first user may check whether the specific person is present in contact lists of a second user, a third user, etc. registered in the contact list 10 of the first user, and the checked result may be transmitted to the first user, thus the respective users may perform a privacy setting to inhibit a search for a specific person registered in their contact lists 10 from the outside

That is, when it is assumed that the first user is a user attempting the search, and the second user is an object to be actually searched, the second personal relationship search application 4b may perform a setting so that a specific acquaintance among acquaintances stored in the personal contact list 10 may not be searched.

Further, since the phone number information stored in the contact list 10 may be opened to be searchable or may remain private to be unsearchable when relationship search is attempted, each contact list 10 is provided with a separate search privacy setting window 18 (see FIG. 5).

Meanwhile, in the present invention, the second user may keep all information in the contact list 10 private with respect to the search attempt of the first user. That is, the second personal relationship search application 4b may perform a setting so that the personal contact list 10 may not be allowed when the first personal relationship search application 4a requests a search for a specific person.

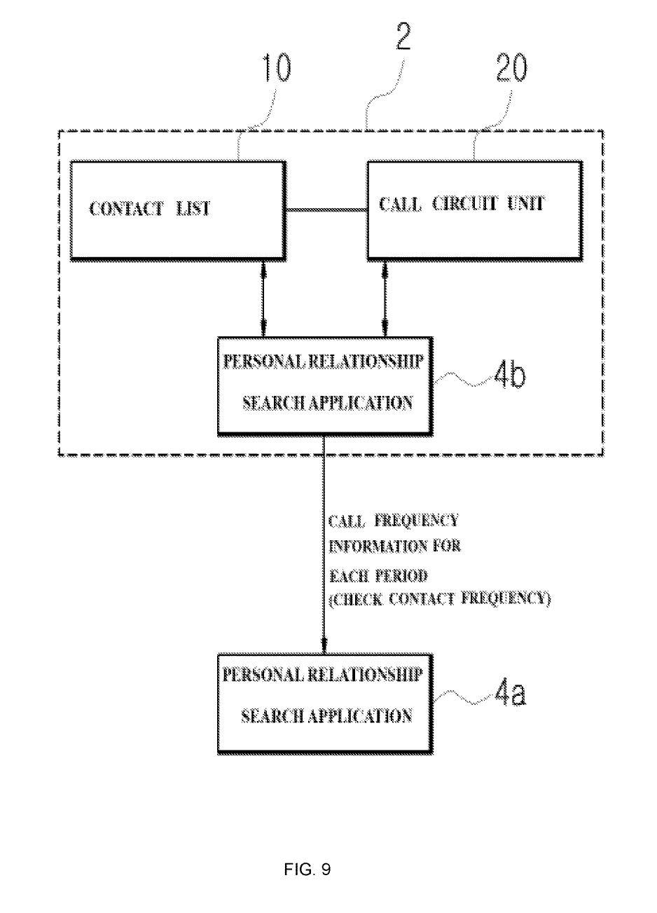

FIG. 9 is a diagram illustrating an affinity check state based on an access frequency through the personal relationship network search system according to the embodiment of the present invention.

Referring to FIG. 9, the personal relationship network search system according to the embodiment of the present invention may check the level of affinity between a specific person and an acquaintance at the time of searching a position of the specific person in the personal relationship network including the contact lists 10 of acquaintances.

The level of affinity may be checked by various methods, for example, by checking a calling frequency. The second personal relationship search application 4b checks a call frequency with respect to a specific relationship searcher in association with a call circuit unit 20, and transmits the result thereof to the first personal relationship search application 4a.

In this case, the second personal relationship search application 4b is a general term for an application through which the specific relationship searcher in the contact list 10b of the second user terminal 2b is searched, and thus the application may also be a fifth personal relationship search application 4e.

Further, the present invention is not limited to the case in which a third party checks a level of affinity by only checking a call frequency, but the level of affinity may also be checked by checking a text message transmission frequency.

Meanwhile, when the first user searches a specific relationship searcher through the personal relationship network search system according to the embodiment of the present invention, if it is assumed that the specific relationship searcher is stored in the contact list 10c of the third user, the level of affinity between the second user and the third user is important as well as the level of affinity between a person having the specific relationship searcher and the third user, and the level of affinity that each user directly feels with respect to a specific person is also important.

Therefore, preferably, the contact list 10 of each user terminal 2 in the present invention is configured so that the index of the level of affinity with respect to a phone number included in the contact list 10 is separately input.

Further, it is preferable to allow the level of affinity between a person having a specific relationship argument and a user of which a contact list is searched to be numerically confirmed by providing the index of the level of affinity together when a search for a specific relationship searcher is attempted.

Meanwhile, since an index of a level of affinity of the person having the specific relationship searcher with respect to the user of which the contact list is searched may also be provided together, the level of affinity felt by the user and the level of affinity felt by the relationship searcher may be different from each other.

To this end, the first and second personal relationship search applications 4a and 4b are configured to indicate the index of the level of affinity by an input of a selection of the user with respect to acquaintances included in the personal contact list 10, and provide the index of the level of affinity to the user attempting the search at the time of searching the acquaintance.

More specifically, if Changhee, Yeongsu, and Cheolsu are present in the contact list 10 of the first user, and a search for a newly met person having a relationship searcher “Heecheol” is attempted, the personal relationship search application 4 searches whether “Heecheol” is present in the contact lists 10 of “Changhee, Yeongsu, and Cheolsu”.

If “Heecheol” is searched in the contact list 10 of “Cheolsu,” an index of a level of affinity of “Cheolsu” with respect to “Heecheol” and an index of a level of affinity of “Heecheol” with respect to “Cheolsu” input by Heecheol may be transmitted to the first user, such that the first user may recognize the level of affinity between “Cheolsu” and “Heecheol”.

In this case, the index of the level of affinity may be indicated as numbers, and the level of affinity may be indicated by being selected from a range of 1 to 5 or 10 to 100.

Meanwhile, the user may directly input the index of the level of affinity, and the affinity may also be indicated by inputting the number of actual offline face-to-face meeting, in addition to the index of the level of affinity reflecting a subjective feeling of the user.

The index of the level of affinity directly input by the user is an input of subjective feeling of the user himself/herself, but the number of offline face-to-face meeting is based on an objective fact, therefore objectivity may be guaranteed.

The number of offline face-to-face meeting is also input directly by the user, and the number of meeting with yearly basis or monthly basis may be input and registered in the contact list 10 by the user, and transmitted together with relevant information at the time of the search for an acquaintance registered in the contact list 10.

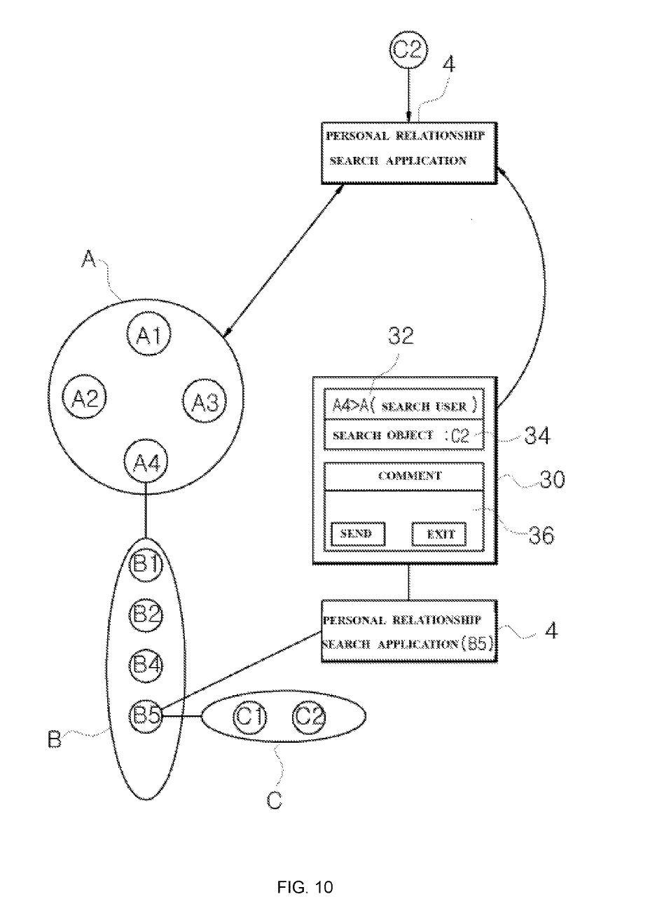

FIG. 10 is a diagram illustrating a transmission state of a comment on the relationship searcher through the personal relationship network search system according to the embodiment of the present invention.

Referring to FIG. 10, the second personal relationship search application 4b included in the personal relationship network search system according to the embodiment of the present invention is configured so that search request attempt information of the first personal relationship search application 4a with respect to a specific relationship searcher is output on a screen to be available.

That is, the second personal relationship search application 4b includes an input window 30, in which comment information for the specific relationship searcher is input in response to the search request attempt information of the first personal relationship search application 4a with respect to the specific relationship searcher, and may be transmitted to the first personal relationship search application 4a, on a screen.

The input window 30 includes a search route window 32 indicating a search route, a search object display window 34 displaying a search object, and a comment input window 36 for inputting the comment.

That is, when an input of a relationship searcher of C2 is attempted by the personal relationship search application 4 of a user A, a search for “C2” is requested to acquaintances (A1, A2, A3 and A4) stored in a contact list 10 of a user terminal of A.

If the search request signal for “C2” is transmitted through acquaintances B1, B2, B3 and B4 stored in a contact list B of the user A4, and when “C2” is searched in a contact list C of a user B5 who is one of acquaintances, as illustrated in FIG. 10, information on a search route and a search object is output in the input window 30 output through the personal relationship search application 5 of the user B5.

Further, the comment input window 36 is output, thus the user B5 may input a comment like “C2 is a very reliable person” through the comment input window 36 to transmit the comment to the user A who is the first user attempting the search.

Meanwhile, the first and second personal relationship search applications 4a and 4b may transmit information pre-registered by the user (e.g. advertisement) together through the personal relationship network when the personal relationship network search is attempted by acquaintances included in the personal contact list 10.

Meanwhile, the personal relationship search system and the method therefor according to the embodiment of the present invention are not limited to the above described embodiment but may be variously changed without departing from the technical subjects thereof.

### DESCRIPTION OF REFERENCE NUMERALS

a. 2: user terminal, 4: personal relationship search application
b. 6: electronic business card, 10: contact list
c. 14: relationship searcher, 20: call circuit unit
d. 36: comment input window

1. A personal relationship network search method, comprising:
a) receiving, by a first personal relationship search application 4a installed in a first user terminal 2a, a relationship searcher;
b) transmitting, by a first personal relationship search application 4a, relationship searcher information to a second personal relationship search application 4b of an acquaintance stored in a contact list 10;
c) determining, by the second personal relationship search application 4b, whether the relationship searcher is pre-stored in a contact list 10 of a second user terminal 2b; and
d) when the relationship searcher is pre-stored, transmitting, by the second personal relationship search application 4b, the personal relationship information to the first personal relationship search application 4a.

2. The method of claim 1, wherein in the step b), first user information or a phone number of the first user terminal 2a is further transmitted together with the relationship searcher.

3. The method of claim 1, further comprising: before the step a), registering, by the second personal relationship search application 4b, personal information of a second user to be searchable.

4. The method of claim 1, further comprising: before the step a), storing the same type of identification information as the relationship searcher in the contact list 10 of the second user terminal 2b.

5-6. (canceled)

7. The method of claim 1, wherein the step d) further includes, when the relationship searcher is pre-stored, checking, by the second personal relationship search application 4b, whether both of the acquaintance and the relationship searcher store each other's phone number, and transmitting the checked information to the first personal relationship search application 4a to determine a level of affinity.

8. The method of claim 1, further comprising: before the step a), performing, by the second personal relationship search application 4b, a setting so that a search in the personal contact list 10 is not allowed when the first personal relationship search application 4a requests a search for a specific person, and editing so that a remote search in the contact list is not allowed.

9. The method of claim 1, wherein the step d) further includes, transmitting, information on a fact that the first personal relationship search application 4a requests a search for the relationship searcher to the second personal relationship search application 4b.

10. The method of claim 1, wherein the step d) further includes, if the second personal relationship search application 4b fails to search the relationship searcher, expanding a personal relationship pool to be searched to a third personal relationship search application 4c of acquaintances stored in a contact list 10 of a second user.

11. The method of claim 1, further comprising: before the step a), performing, by the second personal relationship search application 4b, a setting so that a specific acquaintance of acquaintances included in a personal contact list 10 is unsearchable, and editing the personal contact list 10.

12. The method of claim 1, further comprising:
after the step d), outputting, by the second personal relationship search application 4b, an input window, in which comment information for the relationship searcher is input when receiving search request attempt information for the relationship searcher, and is transmitted to the first personal relationship search application 4a, on a screen; and
transmitting the comment information to the first personal relationship search application 4a at the time of inputting the comment.

13. A personal relationship network search system, comprising:
a first personal relationship search application 4a installed in a first user terminal 2a owned by a first user, and configured to search whether a specific relationship searcher is included in a personal relationship network that is formed based on a personal contact list 10 opened to be searchable to acquaintances, and request to determine that the specific relationship searcher is included in any acquaintance's personal contact list 10; and
a second personal relationship search application 4b installed in a second user terminal 2b owned by a second user who is an acquaintance of the first user, and configured to compare the specific relationship searcher with a personal contact list 10 thereof by receiving from the first personal relationship search application 4a a request signal for searching whether the specific relationship searcher is included in the personal contact list thereof, and transmit a signal informing that a person having the specific relationship searcher is an acquaintance to the first personal relationship search application 4a when the specific relationship searcher is included in the personal contact list 10.

14-16. (canceled)

17. The system of claim 13, wherein whether a phone number of a user terminal 2 having a personal contact list 10 in which the relationship searcher is searched is registered in a personal contact list 10 of the relationship searcher is checked through a personal relationship search application 4 owned by the relationship searcher.

18. (canceled)

19. The system of claim 13, wherein the personal relationship search application 4 checks to which the relationship searcher belongs any classification (family, customer, friend, relative, others) in the personal contact list 10 in which the relationship searcher is searched, and transmits the result to the user attempting the search.

20. The system of claim 13, wherein the second personal relationship search application 4b performs a setting so that a search in the personal contact list 10 is not allowed when the first personal relationship search application 4a requests a search for a specific person.

21. The system of claim 13, wherein the second personal relationship search application 4b performs a setting so that a specific acquaintance of acquaintances included in the personal contact list 10 is unsearchable.

22. The system of claim 13, wherein the second personal relationship search application 4b is configured to check a call frequency with respect to the specific relationship searcher in association with a call circuit unit 20 and transmit the checked result to the first personal relationship search application 4a.

23. (canceled)

24. The system of claim 13, wherein the second personal relationship search application 4b includes an input window, in which comment information for the specific relationship searcher is input in response to search request attempt information of the first personal relationship search application 4a with respect to the specific relationship searcher, and is transmitted to the first personal relationship search application 4a.

25. The system of claim 13, further comprising: a personal relationship information management server configured to store the same information included in the personal contact list 10s of the first and second personal relationship search applications 4a and 4b in advance, and extract and provide information on whether the specific relationship searcher is present and personal relationship network information (information on connection route between users to the relationship searcher) thereof in response to a search request for the relationship searcher from the first and second personal relationship search applications 4a and 4b.

26. (canceled)

27. The system of claim 13, wherein the first and second personal relationship search applications 4a and 4b are configured to indicate an index of a level of affinity by an input of a selection of the user with respect to an acquaintance included in the personal contact list 10 and provide the index of the level of affinity to a user attempting a search at the time of searching for the acquaintance.

28. The system of claim 13, wherein the first and second personal relationship search applications 4a and 4b are configured to indicate the number of offline face-to-face meeting with each acquaintance within a predetermined period by an input of a selection of the user with respect to an acquaintance included in the personal contact list 10 and provide the number of offline face-to-face meeting to a user attempting a search at the time of searching for the acquaintance.
